(19) United States
(12) Patent Application Publication
(10) Pub. No.: US 2019/0277143 A1
(43) Pub. Date: Sep. 12, 2019

(54) HIGH-TEMPERATURE COMPONENT FOR GAS TURBINE, GAS TURBINE BLADE AND GAS TURBINE

(71) Applicant: MITSUBISHI HEAVY INDUSTRIES, LTD., Tokyo (JP)

(72) Inventor: Tatsuo ISHIGURO, Tokyo (JP)

(21) Appl. No.: 16/463,584

(22) PCT Filed: Nov. 27, 2017
(86) PCT No.: PCT/JP2017/042332

§ 371 Date: May 23, 2019

(30) Foreign Application Priority Data
Nov. 30, 2016 (JP) 2016-232044

(51) Int. Cl. F01D 5/18

(52) U.S. Cl. CPC F01D 5/183; F05D 2260/202; F05D 2240/30; F01D 5/186

(57) ABSTRACT

A high-temperature component for a gas turbine includes: a body part; and a porous part configured such that a cooling gas is capable of passing through the porous part. The high-temperature component for a gas turbine is configured such that distribution is created in an arrangement of the porous part or a passing flow rate of the cooling gas at the porous part, in accordance with one or both of distributions of a thermal load and a pressure difference applied to the body part or the porous part. A gas turbine blade includes: a porous part which constitutes at least a trailing edge portion of an airfoil part and through which a cooling gas is passable, and the porous part has a porous rate having such a distribution that the cooling gas inside the airfoil part flows out through the porous part from a trailing edge of the airfoil part.

### TECHNICAL FIELD

The present disclosure relates to a high-temperature component for a gas turbine, a gas turbine blade, and a gas turbine.

### BACKGROUND ART

A gas turbine includes a compressor, a combustor, and a turbine, sucks in atmosphere and compresses the atmosphere with the compressor, combusts a fuel with the combustor to generate high-pressure and high-temperature combustion gas, and rotates the turbine. Further, it is possible to generate electric power and a propelling force from the output of the turbine of the gas turbine.

High-temperature components for a gas turbine such as a combustor, rotor blades and stationary vanes of a turbine, and ring segments are exposed to high-temperature combustion gas, and thus are cooled by cooling air.

For instance, Patent Document 1 discloses a component that can be applied to a gas turbine, which has a substrate with cooling air supply holes formed thereon, and a porous layer formed on the substrate. The porous layer is disposed on the gas-path side were the combustion gas flows, and is cooled as cooling air supplied through the cooling gas supply holes flows through the porous layer.

### CITATION LIST

### Patent Literature

Patent Document 1: U.S. Pat. No. 9,003,657B

### SUMMARY

### Problems to be Solved

In a high-temperature component for a gas turbine, cooling air flows substantially in proportion to the square root of the difference between the inside pressure and the outside pressure (gas-path static pressure).

Herein, there is a pressure distribution on the outer side (gas-path side) of the high-temperature component for a gas turbine. Thus, as disclosed in Patent Document 1, if the distribution of the cooling air supply holes and the thickness and the porous rate of the porous layer are constant, the flow rate of cooling air would be low in a region where the gas-path static pressure is high, and the flow rate of cooling air would be high in a region where the gas-path static pressure is low. Thus, in the porous layer, an undesirable distribution would be created in the flow rate of cooling air. Specifically, in a case where the component is a rotor blade or a stationary vane, when comparing the pressure side and the suction side, the gas-path static pressure of the pressure side is higher than the gas-path static pressure of the suction side. Thus, the flow rate of cooling air is low at the pressure side, and the pressure side gets heated more easily than the suction side. Furthermore, in a case where the component is a rotor blade or a stationary vane, when comparing the leading-edge side and the trailing-edge side, the gas-path static pressure at the trailing-edge side is lower than the gas-path static pressure at the leading-edge side. Thus, the flow rate of cooling air is higher at the trailing-edge side. Accordingly, more than necessary cooling air flows out from the trailing edge side, which may bring about performance deterioration of the gas turbine.

Further, the thermal load applied to a high-temperature component for a gas turbine has a distribution. For instance, the upstream side with respect to the flow direction of combustion gas has a higher thermal load than the downstream side. Such a thermal load distribution may also cause local and excessive heating of a component. Furthermore, depending on the magnitude of the thermal load, it may be unnecessary to provide the porous layer, or to cool the porous layer with cooling air.

Meanwhile, on a trailing-edge portion of a gas turbine blade, a discharge flow passage for cooling gas is disposed to let cooling gas that has cooled the inside of the blade flow out from the trailing edge of the blade. To provide such a discharge flow passage for cooling gas on the trailing-edge portion of the blade, it is necessary to increase the thickness of the trailing-edge portion of the blade, which may reduce the design flexibility of the blade shape.

In view of the above issue, an object of at least one embodiment of the present invention is to provide a high-temperature component for a gas turbine, and a gas turbine whereby it is possible to prevent performance deterioration of a gas turbine due to local and excessive heating of the high-temperature component as well as a local and excessive increase in the flow rate of cooling gas.

Furthermore, in view of the above issue, an object of at least one embodiment of the present invention is to provide a gas turbine blade and a gas turbine whereby it is possible to let cooling gas that has cooled the inside of the blade flow out from the trailing edge of the blade regardless of the thickness of the trailing-edge portion of the blade.

### Solution to the Problems

(1) According to at least one embodiment of the present invention, a high-temperature component for a gas turbine includes: a body part; and a porous part which is provided as a part of the body part or which is disposed on at least a part of the body part, the porous part being configured such that a cooling gas is capable of passing through the porous part. The high-temperature component for a gas turbine is configured such that a distribution is created in an arrangement of the porous part or a passing flow rate of the cooling gas at the porous part, in accordance with one or both of distributions of a thermal load and a pressure difference applied to the body part or the porous part.

With the above configuration (1), the high-temperature component for a gas turbine is configured such that a distribution is created in the arrangement of the porous part or the passing flow rate of cooling gas at the porous part, in accordance with one or both of the distributions of the thermal load and the pressure difference applied to the body part or the porous part. Accordingly, it is possible to prevent local and excessive heating of the body part and the porous part, as well as an excessive and local increase in the passing flow rate of cooling gas.

(2) In some embodiments, in the above configuration (1), the porous part is disposed on at least the part of the body part, the body part has a plurality of cooling gas supply holes formed thereon, for supplying the cooling gas to the porous part, and the plurality of cooling gas supply holes have a distribution determined in accordance with one or both of the distributions of the thermal load and the pressure difference applied to the porous part.

With the above configuration (2), the distribution of the cooling gas supply holes is decided in accordance with one or both of the distributions of the thermal load and the pressure difference applied to the porous part, and thereby it is possible to prevent local and excessive heating of the porous part, as well as an excessive and local increase of the passing flow rate of cooling gas, with a simple configuration.

(3) In some embodiments, in the above configuration (1) or (2), the porous part is disposed on at least the part of the body part, the body part has a plurality of cooling gas supply holes formed thereon, for supplying the cooling gas to the porous part, and the plurality of cooling gas supply holes each have a cross-sectional area determined in accordance with one or both of the distributions of the thermal load and the pressure difference applied to the porous part.

With the above configuration (3), the cross-sectional area of each of the plurality of cooling gas supply holes is decided in accordance with one or both of the distributions of the thermal load and the pressure difference applied to the porous part, and thereby it is possible to prevent local and excessive heating of the porous part, as well as an excessive and local increase of the passing flow rate of cooling gas, with a simple configuration.

(4) In some embodiments, in any one of the above configurations (1) to (3), the body part has a cavity formed between the porous part and at least one of the plurality of cooling gas supply holes, the cavity having a greater cross-sectional area than the cooling gas supply holes.

With the above configuration (4), with the cavity having a greater cross-sectional area than the cooling gas supply hole disposed between the porous part and the cooling gas supply hole, it is possible to supply cooling gas to a broader region of the porous part. As a result, it is possible to prevent local and excessive heating of the porous part, and a local and excessive increase in the passing flow rate of cooling gas.

(5) In some embodiments, in any one of the above configurations (1) to (4), the porous part has a porosity rate having a distribution in accordance with one or both of the distributions of the thermal load and the pressure difference applied to the porous part.

With the above configuration (5), the porosity rate of the porous part has a distribution in accordance with one or both of the distributions of the thermal load and the pressure difference applied to the porous part, and thereby it is possible to prevent local and excessive heating of the porous part, as well as an excessive and local increase of the passing flow rate of cooling gas.

(6) In some embodiments, in any one of the above configurations (1) to (5), the porous part has a thickness having a distribution in accordance with one or both of the distributions of the thermal load and the pressure difference applied to the porous part.

With the above configuration (6), the thickness of the porous part has a distribution in accordance with one or both of the thermal load and the pressure difference applied to the porous part, and thereby it is possible to prevent local and excessive heating of the porous part, as well as an excessive and local increase in the passing flow rate of cooling gas.

(7) In some embodiments, in any one of the above configurations (1) to (6), the body part or the porous part constitutes at least a part of one of a rotor blade, a stationary vane, a ring segment, or a combustor.

With the above configuration (7), for the rotor blade, the stationary vane, the ring segment, or the combustor, which serves as the high-temperature component for a gas turbine, it is possible to prevent local and excessive heating of the porous part, and a local and excessive increase in the passing flow rate of the cooling gas.

(8) According to at least one embodiment of the present invention, a gas turbine blade includes: a porous part which constitutes at least a trailing edge portion of an airfoil part and through which a cooling gas is passable. The porous part has a porous rate having such a distribution that the cooling gas inside the airfoil part flows out through the porous part from a trailing edge of the airfoil part.

With the above configuration (8), the trailing-edge portion of the airfoil part is formed by the porous part, and the cooling gas is allowed to flow through the porous part, whereby it is possible to discharge cooling gas from the trailing edge of the airfoil part even if the thickness of the trailing-edge portion of the airfoil part is small. At this time, with the porous part having a distribution such that cooling gas flows out from the trailing edge of the airfoil part, it is possible to prevent cooling gas from flowing out entirely from the suction side or the pressure side of the trailing-edge portion before arriving at the trailing edge of the airfoil part, which makes it possible to discharge cooling gas from the trailing edge.

(9) According to at least one embodiment of the present invention, a gas turbine includes: the high-temperature component for a gas turbine according to any one of (1) to (7).

With the above configuration (9), for the high-temperature component for a gas turbine, it is possible to prevent local and excessive heating of the porous part, and a local and excessive increase in the passing flow rate of the cooling gas, and thus it is possible to operate a gas turbine under a higher temperature. Accordingly, it is possible to provide a gas turbine with a higher efficiency.

(10) According to at least one embodiment of the present invention, a gas turbine includes: the gas turbine blade according to (8).

With the above configuration (10), it is possible to discharge cooling gas from a trailing edge of a trailing-edge portion, and improve the design flexibility of the gas turbine blade. As a result, it is possible to provide a gas turbine blade having a highly efficient shape, and thus it is possible to provide a gas turbine with a high efficiency.

### Advantageous Effects

According to at least one embodiment of the present invention, it is possible to provide a high-temperature component for a gas turbine, and a gas turbine whereby it is possible to prevent performance deterioration of a gas turbine due to local and excessive heating and a local and excessive increase in the flow rate of cooling gas.

According to at least one embodiment of the present invention, it is possible to provide a gas turbine blade and a gas turbine whereby it is possible to let cooling gas that has cooled the inside of the blade flow out from the trailing edge of the blade regardless of the thickness of the trailing-edge portion of the blade.

### BRIEF DESCRIPTION OF DRAWINGS

FIG. 1 is a schematic configuration diagram of a gas turbine to which a high-temperature component for a gas turbine according to an embodiment of the present invention is applied.

FIG. 2 is a schematic perspective view of a stationary vane 11 which can be applied to a turbine as a high-temperature component for a gas turbine according to an embodiment of the present invention.

FIG. 3 is a schematic perspective view of a rotor blade which can be applied to a turbine as a high-temperature component for a gas turbine according to an embodiment of the present invention.

FIG. 4 is a schematic perspective view of a ring segment which can be applied to a turbine as a high-temperature component for a gas turbine according to an embodiment of the present invention.

FIG. 5 is a vertical cross-sectional view schematically showing a ring segment according to an embodiment of the present invention.

FIG. 6 is a vertical cross-sectional view schematically showing a ring segment according to an embodiment of the present invention.

FIG. 7 is a vertical cross-sectional view schematically showing a ring segment according to an embodiment of the present invention.

FIG. 8 is a diagram for describing a ring segment according to an embodiment of the present invention: (a) is a schematic vertical cross-sectional view of a ring segment, and (b) is a graph schematically showing the distribution of the porous rate of a porous part of a ring segment.

FIG. 9 is a vertical cross-sectional view schematically showing a ring segment according to an embodiment of the present invention.

FIG. 10 is a vertical cross-sectional view schematically showing a ring segment according to an embodiment of the present invention.

FIG. 11 is a vertical cross-sectional view schematically showing a ring segment according to an embodiment of the present invention.

FIG. 12 is a diagram for describing a ring segment according to an embodiment of the present invention: (a) is a schematic vertical cross-sectional view of a ring segment, and (b) is a graph schematically showing the distribution of the porous rate of a ring segment.

FIG. 13 is a vertical cross-sectional view schematically showing a ring segment according to an embodiment of the present invention.

FIG. 14 is a vertical cross-sectional view schematically showing a ring segment according to an embodiment of the present invention.

FIG. 15 is a diagram for describing a rotor blade according to an embodiment of the present invention: (a) is a schematic lateral cross-sectional view of an airfoil part, (b) is a graph schematically showing the distribution of static pressure on the outer side of the pressure side of the airfoil part, the distribution of static pressure of the outer side of the suction side of the airfoil part, and the distribution of static pressure inside the airfoil part, with respect to the flow direction of combustion gas, and (c) is a graph schematically showing the distribution of the porous rate of the porous part on the pressure side and that on the suction side with respect to the flow direction of combustion gas.

FIG. 16 is a diagram for describing a rotor blade according to an embodiment of the present invention: (a) is a schematic lateral cross-sectional view of an airfoil part, (b) is a graph schematically showing the distribution of thermal load on the outer side of the pressure side of the airfoil part and the distribution of thermal load on the outer side of the suction side of the airfoil part, with respect to the flow direction of combustion gas, and (c) is a graph schematically showing the distribution of the porous rate of the porous part on the pressure side and that on the suction side with respect to the flow direction of combustion gas.

FIG. 17 is a lateral cross-sectional view schematically showing a rotor blade according to an embodiment of the present invention.

FIG. 18 is a partial perspective view schematically showing a part of the airfoil part of a stationary vane according to an embodiment of the present invention.

FIG. 19 is a flowchart schematically showing the procedure of the method of producing a porous part to be applied to a high-temperature component for a gas turbine according to an embodiment of the present invention.

FIG. 20 is a schematic perspective view for describing an example of a slurry applying step.

FIG. 21 is a schematic plan view for describing an example of a slurry applying step.

FIG. 22 is a schematic perspective view showing a plurality of woven fabric sheets prepared in an assembly preparing step.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

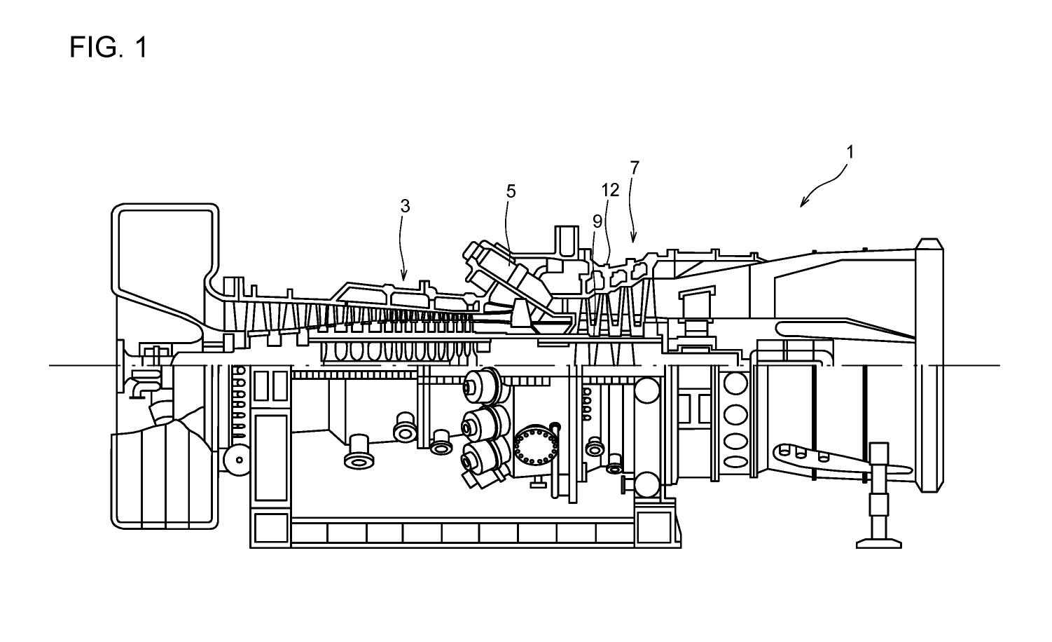

FIG. 1 is a schematic configuration diagram of a gas turbine 1 to which a high-temperature component for a gas turbine according to an embodiment of the present invention is applied.

As depicted in FIG. 1, the gas turbine 1 includes a compressor (compressing part) 3, a combustor (combustion part) 5, and a turbine (turbine part) 7. The compressor 3 sucks in and compresses atmosphere and generates compressed air. The combustor 5 is supplied with the compressed air from the compressor 3 with fuel, and combusts the fuel to produce combustion gas that has a high pressure and a high temperature. The turbine 7 rotates a rotor shaft 9 utilizing combustion gas. The rotor shaft 9 is connected to the compressor 3, and is connected to a generator (not depicted). As the torque outputted by the rotor shaft 9 drives the compressor 3, the generator generates electricity.

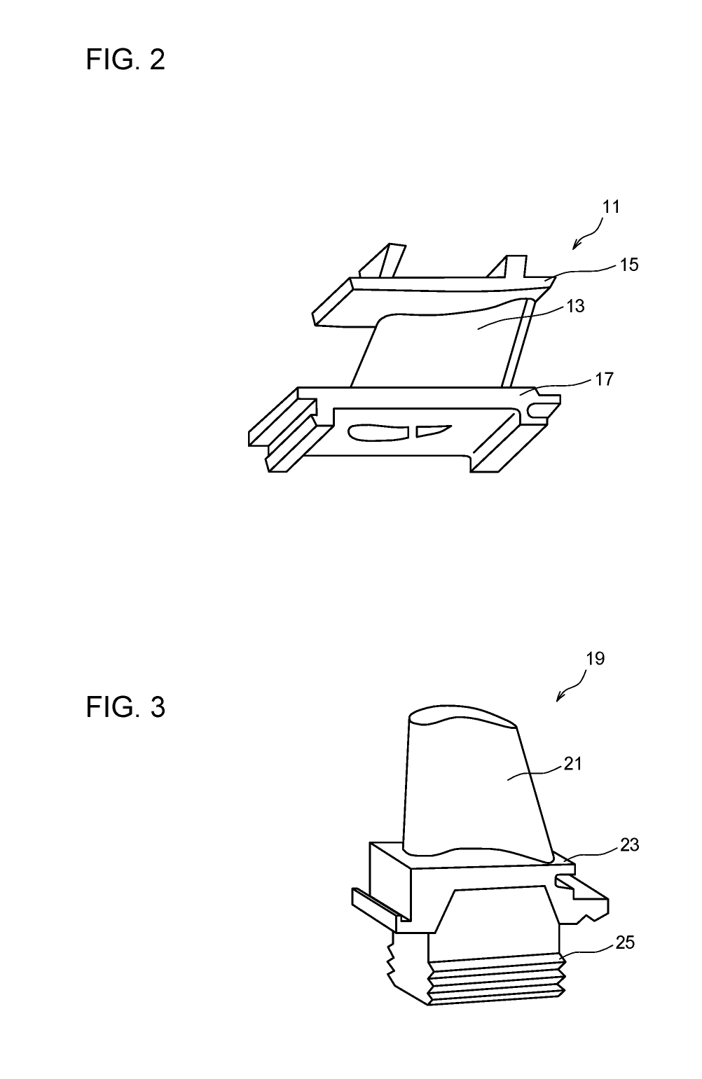

FIG. 2 is a schematic perspective view of a stationary vane 11 which can be applied to a turbine 7 as a high-temperature component 10 for a gas turbine according to an embodiment of the present invention. The plurality of stationary vanes 11 are fixed to a housing (casing) 12 of the turbine 7 in a state of being arranged in the circumferential direction of the rotor shaft 9. Each stationary vane 11 has an airfoil part 13 and platforms 15, 17 disposed on opposite sides of the airfoil part 13. A flow passage of combustion gas (gas path) is defined between the platforms 15, 17. Thus, the surfaces of the platforms 15, 17 and the surface of the airfoil part 13 that face the gas path are exposed to combustion gas.

FIG. 3 is a schematic perspective view of a rotor blade 19 which can be applied to a turbine 7 as a high-temperature component 10 for a gas turbine according to an embodiment of the present invention. The plurality of rotor blades 19 are fixed to the rotor shaft 9 in a state of being arranged in the circumferential direction of the rotor shaft 9. The rotor blade 19 has an airfoil part 21, a platform 23 disposed on one side of the airfoil part 21, and a blade root portion 25 protruding from the platform 23 opposite to the airfoil part 21. The blade root portion 25 is embedded into the rotor shaft 9, and thereby the rotor blade 19 is fixed to the rotor shaft 9. The platform 23 is disposed so as to cover the rotor shaft 9, and the surface of the platform 23 on the side of the airfoil part 21 defines a gas path. Thus, the surface of the platform 23 and the surface of the airfoil part 21 that face the gas path are exposed to combustion gas. The combustion gas hits the airfoil parts 21 of the plurality of rotor blades 19, and thereby rotate the rotor shaft 9.

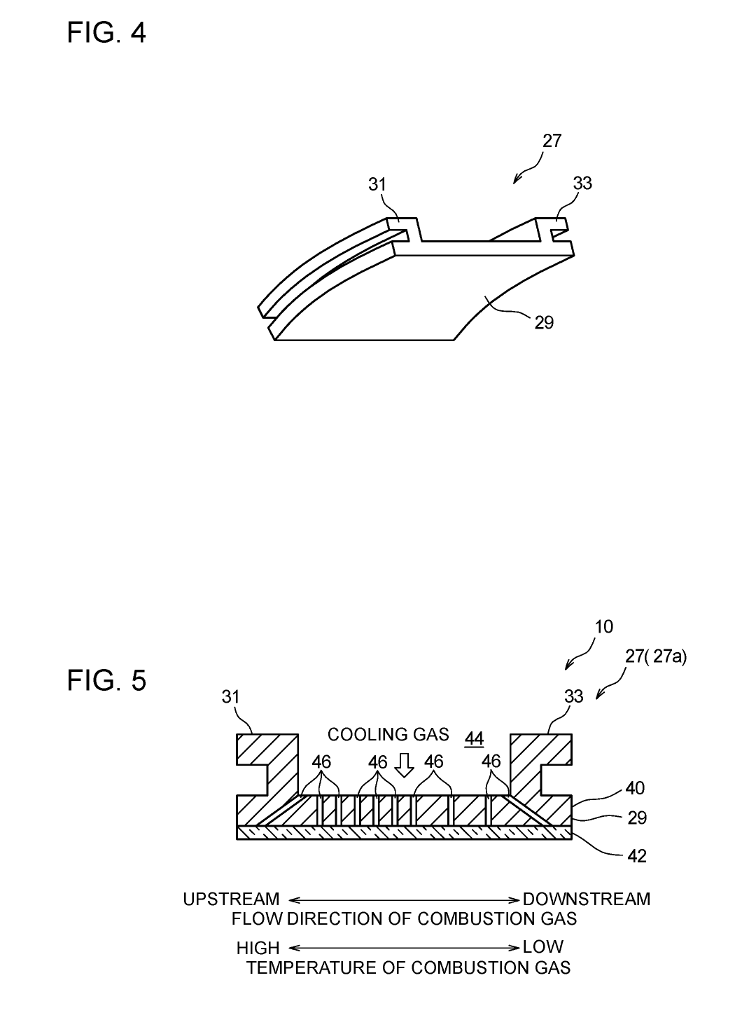

FIG. 4 is a schematic perspective view of a ring segment 27 which can be applied to the turbine 7 as the high-temperature component 10 for a gas turbine according to an embodiment of the present invention. The plurality of ring segments 27 are fixed to the housing 12 of the turbine 7 in a state of being arranged in the circumferential direction of the rotor shaft 9. The ring segments 27 are disposed on the outer side of the rotor blades 19 with respect to the radial direction of the rotor shaft 9. The plurality of ring segments 27 arranged in the circumferential direction surround the plurality of rotor blades 19 arranged in the circumferential direction. Each ring segment 27 has a wall portion 29 that constitutes a surrounding wall that surrounds the rotor blades 19 and engaging portions 31, 33 for fixing the wall portion 29 to the housing 12. The surface (concave curved surface) of the wall portion 29 on the side of the rotor blades 19 defines the gas path, and the surface of the wall portion 29 that faces the gas path is exposed to combustion gas.

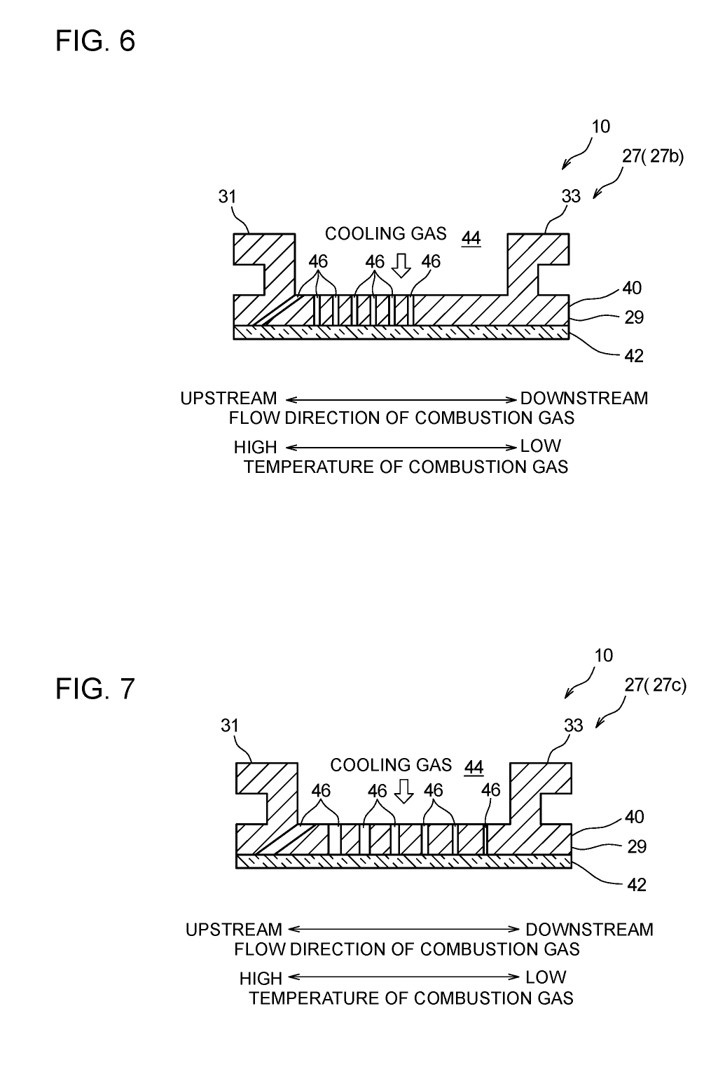

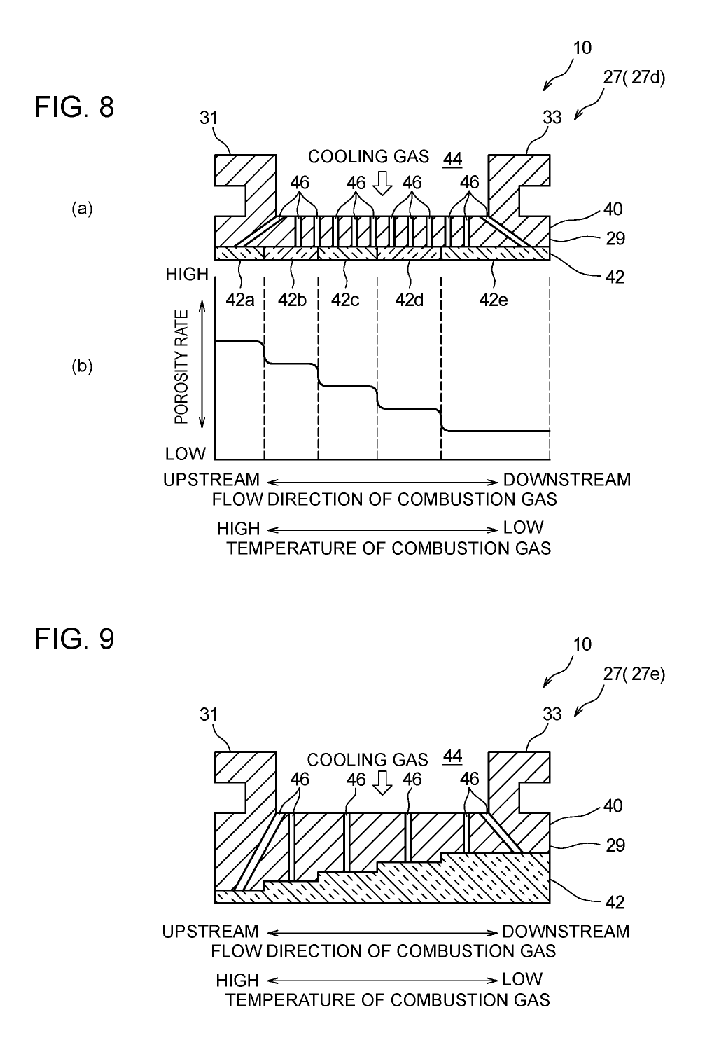

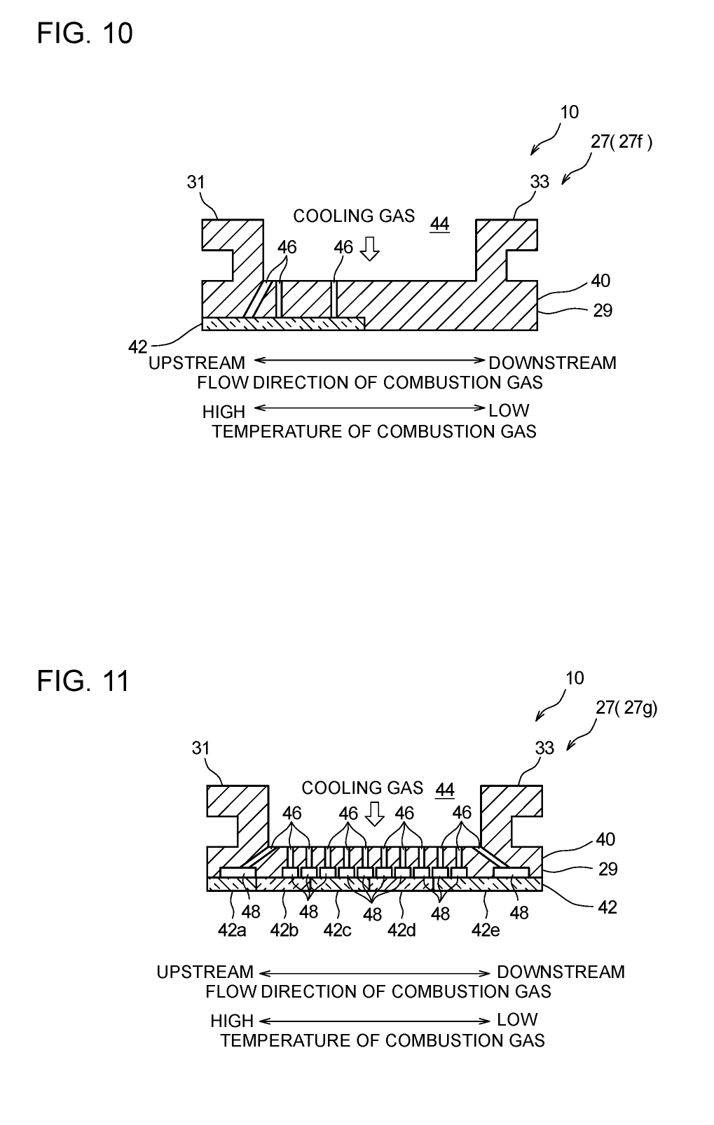

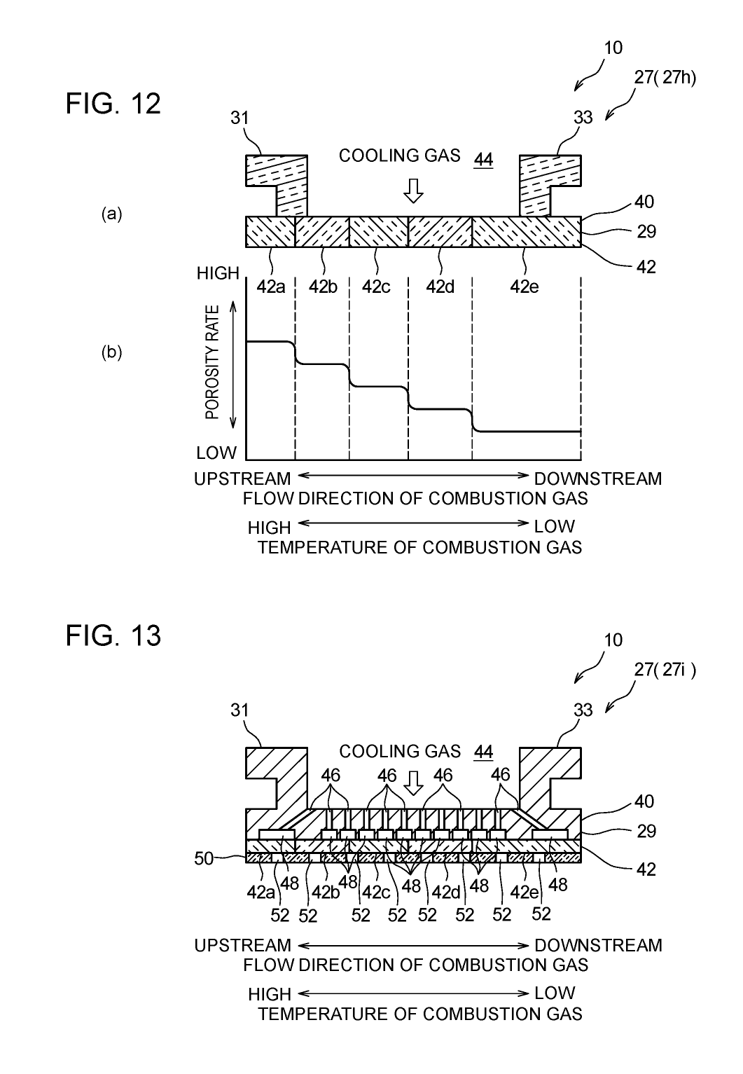

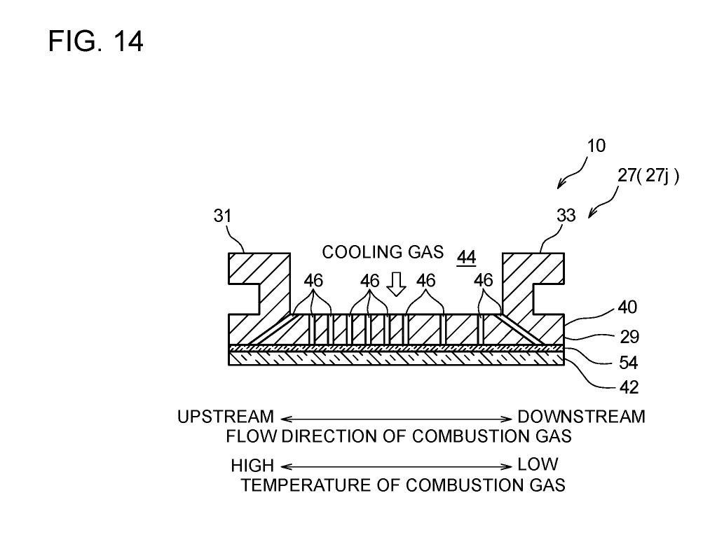

FIG. 5 is a vertical cross-sectional view schematically showing a ring segment 27 (27a) according to an embodiment of the present invention. FIG. 6 is a vertical cross-sectional view schematically showing a ring segment 27 (27b) according to an embodiment of the present invention. FIG. 7 is a vertical cross-sectional view schematically showing a ring segment 27 (27c) according to an embodiment of the present invention. FIG. 8 is a diagram for describing a ring segment 27 (27d) according to an embodiment of the present invention: (a) is a schematic vertical cross-sectional view of the ring segment 27 (27d), and (b) is a graph schematically showing the distribution of the porous rate of a porous part of the ring segment 27 (27d). FIG. 9 is a vertical cross-sectional view schematically showing a ring segment 27 (27e) according to an embodiment of the present invention. FIG. 10 is a vertical cross-sectional view schematically showing a ring segment 27 (27f) according to an embodiment of the present invention. FIG. 11 is a vertical cross-sectional view schematically showing a ring segment 27 (27g) according to an embodiment of the present invention. FIG. 12 is a diagram for describing a ring segment 27 (27h) according to an embodiment of the present invention: (a) is a schematic vertical cross-sectional view of the ring segment 27 (27h), and (b) is a graph schematically showing the distribution of the porous rate of the ring segment 27 (27h). FIG. 13 is a vertical cross-sectional view schematically showing a ring segment 27 (27i) according to an embodiment of the present invention. FIG. 14 is a vertical cross-sectional view schematically showing a ring segment 27 (27j) according to an embodiment of the present invention.

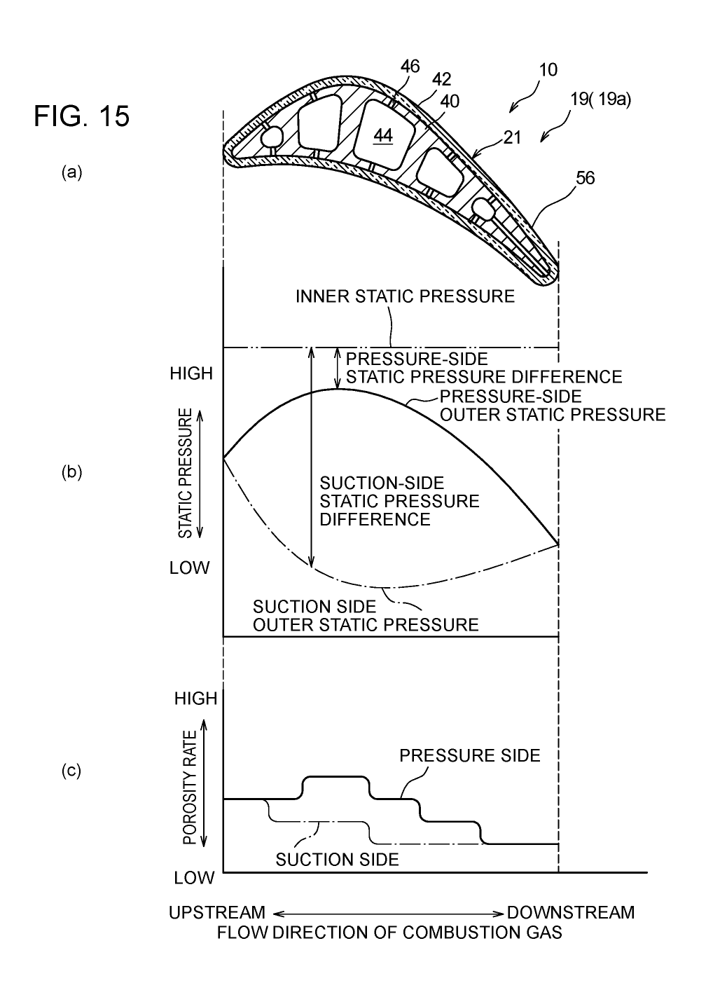

FIG. 15 is a diagram for describing the rotor blade 19 (19a) according to an embodiment of the present invention: (a) is a schematic lateral cross-sectional view of the airfoil part 21, (b) is a graph schematically showing the distribution of static pressure on the outer side of the pressure side of the airfoil part 21, the distribution of static pressure on the outer side of the suction side of the airfoil part 21, and the distribution of static pressure inside the airfoil part 21, with respect to the flow direction of combustion gas, and (c) is a graph schematically showing the distribution of the porous rate of the porous part on the pressure side and that on the suction side with respect to the flow direction of combustion gas.

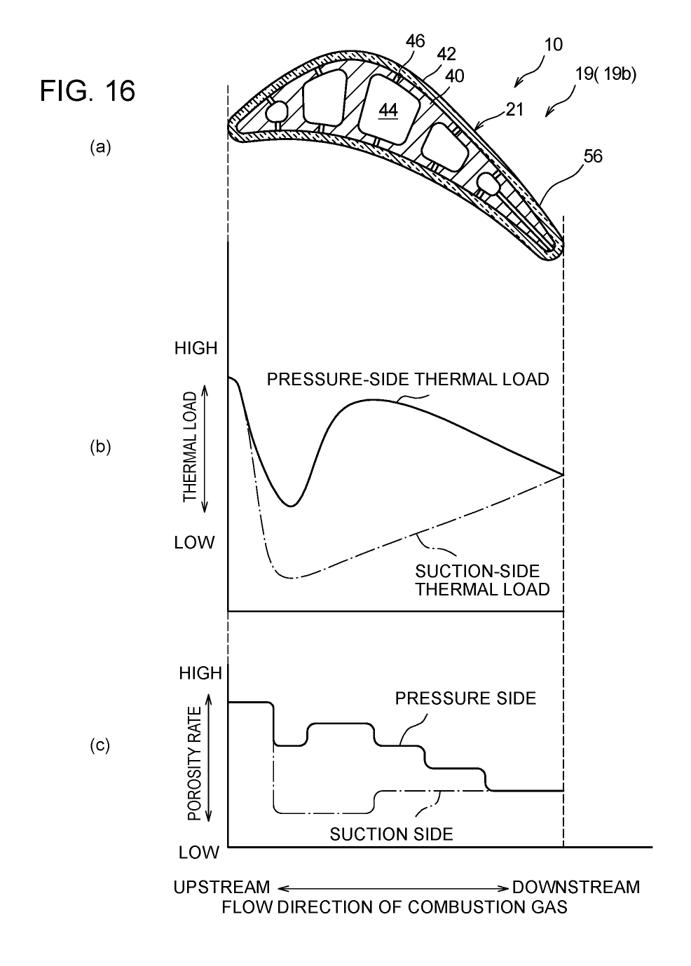

FIG. 16 is a diagram for describing the rotor blade 19 (19b) according to an embodiment of the present invention: (a) is a schematic lateral cross-sectional view of the airfoil part 21, (b) is a graph schematically showing the distribution of thermal load on the outer side of the pressure side of the airfoil part 21 and the distribution of thermal load of the outer side of the suction side of the airfoil part 21, with respect to the flow direction of combustion gas, and (c) is a graph schematically showing the distribution of the porous rate of the porous part on the pressure side and that on the suction side with respect to the flow direction of combustion gas.

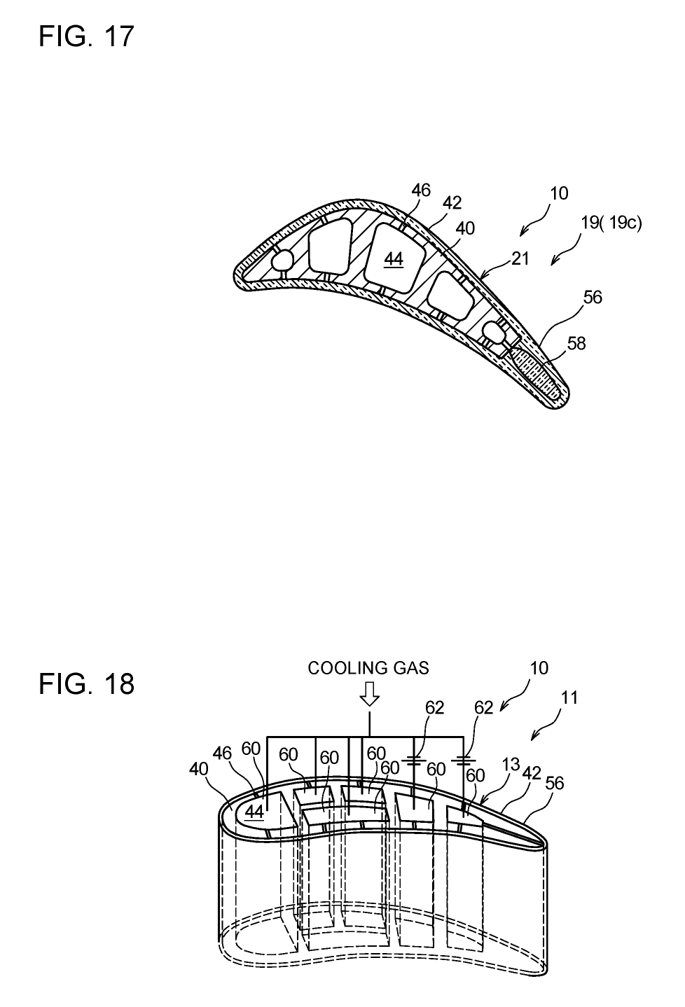

FIG. 17 is a lateral cross-sectional view schematically showing a rotor blade 19 (19c) according to an embodiment of the present invention.

FIG. 18 is a partial perspective view schematically showing a part of the airfoil part 13 of a stationary vane 11 according to an embodiment of the present invention.

The high-temperature component 10 for a gas turbine according to an embodiment of the present invention has a body part 40 and a porous part 42, as depicted in FIGS. 5 to 18.

The body part 40 constitutes a basic framework that forms the high-temperature component 10 for a gas turbine. For instance, the body part 40 includes heat-resistant metal such as a Ni-based alloy, or ceramic matrix composites (CMC). CMC includes, for instance, ceramic fibers such is SiC and Al₂O₃, and ceramic matrix that covers the ceramic fibers such as SiC and Al₂O₃. Further, a middle layer of BN or the like is disposed between the ceramic fibers and the ceramic matrix.

The porous part 42 is provided as at least a part of the body part 40, or disposed on at least a part of the body part 40. For instance, in a case where the porous part 42 is provided as at least a part of the body part 40, the porous part 42 constitutes a part of a wall of the high-temperature component 10 for a gas turbine. Further, for instance, in a case where the porous part 42 is disposed on at least a part of the body part 40, the porous part 42 constitutes a coating layer that covers the outer surface of the high-temperature component for a gas turbine.

The porous part 42 has small pores (not depicted), and cooling gas is capable of passing through the porous part 42 via the pores. In other words, the porous part 42 has a microstructure for cooling. The cooling gas is air, for instance. The porous part 42 includes, for instance, foam metal (porous metal) such as NiAl, a porous ceramic such as yttrium-stabilized zirconium, or porous CMC. The porous part 42 may be produced by using a 3D printer, for instance.

Furthermore, the high-temperature component 10 for a gas turbine is configured such that a distribution is created in the arrangement of the porous part 42 or the passing flow rate of cooling gas at the porous part 42, in accordance with one or both of the distributions of the thermal load and the pressure difference applied to the body part 40 or the porous part 42.

At least a part of the porous part 42 is disposed on the gas-path side where combustion gas flows, in the high-temperature component 10 for a gas turbine. The high-temperature component 10 for a gas turbine has an internal space 44 separated from the gas path by the porous part 42, and the internal space 44 is supplied with cooling gas that has a higher pressure than combustion gas flowing through the gas path. The porous part 42 is cooled by inner-surface cooling or impingement cooling where the body part 40 that defines the internal space 44 is cooled, or transpiration cooling or micro-channel cooling where cooling gas passes through the porous part 42 in accordance with the pressure difference between the static pressure of cooling gas in the internal space 44 and the static pressure of combustion gas in the gas path.

Herein, the thermal load and the pressure difference are applied to the high-temperature component 10 for a gas turbine, that is, the body part 40 or the porous part 42, not uniformly, but with a distribution.

With the above configuration, the high-temperature component 10 for a gas turbine is configured such that a distribution is created in the arrangement of the porous part 42 or the passing flow rate of cooling gas at the porous part 42, in accordance with one or both of the distributions of the thermal load and the pressure difference applied to the body part 40 or the porous part 42. Accordingly, it is possible to prevent local and excessive heating of the body part 40 and the porous part 42, as well as an excessive and local increase in the passing flow rate of cooling gas.

In some embodiments, as depicted in FIGS. 5 to 11 and FIGS. 13 to 18, the porous part 42 is disposed on at least a part of the body part 40. That is, the porous part 42 is formed to have a layer shape so as to cover at least a part of the body part 40, and constitutes a thermal insulation layer.

The body part 40 has a plurality of cooling gas supply holes 46 for supplying cooling gas to the porous part 42. The cooling gas supply holes 46 connect the internal space 44 and the porous part 42 fluidically.

Furthermore, as depicted in FIGS. 5, 6, and 14, the high-temperature component 10 for a gas turbine is configured such the plurality of cooling gas supply holes 46 have a distribution decided in accordance with one or both of the distributions of the thermal load and the pressure difference applied to the porous part 42.

With the above configuration, the distribution of the cooling gas supply holes 46 is decided in accordance with one or both of the distributions of the thermal load and the pressure difference applied to the porous part 42, and thereby it is possible to prevent local and excessive heating of the porous part 42, as well as an excessive and local increase in the passing flow rate of cooling gas, with a simple configuration.

For instance, the thermal load applied to the porous part 42 is higher toward the upstream side with respect to the flow direction of combustion gas. Thus, the cooling gas supply holes 46 are formed such that more cooling gas supply holes 46 are formed (the density of the cooling gas supply holes 46 increases) toward the upstream with respect to the flow direction of combustion gas.

Further, for instance, the pressure difference applied to the porous part 42 is smaller toward the upstream side with respect to the flow direction of combustion gas. Thus, the cooling gas supply holes 46 are formed such that more cooling gas supply holes 46 are formed toward the upstream with respect to the flow direction of combustion gas.

Furthermore, for instance, in a case where the high-temperature component 10 for a gas turbine is a blade such as the stationary vane 11 or the rotor blade 19, the static pressure of the gas path has a distribution at each of the suction side and the pressure side of the airfoil parts 13, 21, as depicted in part (b) of FIG. 15, and the pressure difference has a distribution. Specifically, the pressure difference is the smallest at the middle section with respect to the flow direction at the pressure side, and the largest at the middle section with respect to the flow direction at the suction side. Thus, the number of cooling gas supply holes 46 may be decided in accordance with the above distribution of pressure difference, so that the number of cooling gas supply holes 46 increases as the pressure difference becomes smaller, at each of the suction side and the pressure side of the airfoil parts 13, 21.

Furthermore, for instance, in a case where the high-temperature component 10 for a gas turbine is a blade such as the stationary vane 11 or the rotor blade 19, the thermal load has a distribution at each of the suction side and the pressure side of the airfoil parts 13, 21, as depicted in part (b) of FIG. 16. Specifically, the thermal load at the pressure side is the highest at the leading edge with respect to the flow direction, reaches its minimum at a section immediately downstream the leading edge, gradually increases over a section downstream thereof, and then gradually decreases to the trailing edge over a section further downstream thereof. The thermal load at the suction side is the highest at the leading edge with respect to the flow direction, reaches its minimum at a section immediately downstream the leading edge, and then gradually increases to the trailing edge over a section downstream thereof. Thus, the number of cooling gas supply holes 46 may be decided in accordance with the above distribution of thermal load, so that the number of cooling gas supply holes 46 increases as the thermal load becomes higher, at each of the suction side and the pressure side of the airfoil parts 13, 21.

Furthermore, as depicted in FIG. 6, in a case where there is a region in the porous part 42 where the thermal load is low, cooling gas supply holes 46 for supplying cooling gas may not necessarily be disposed in the region. In other words, the cooling gas supply holes 46 may be disposed so as to supply cooling gas only to a region of the porous part 42 where the thermal load is high. Specifically, the cooling gas supply holes 46 may be disposed only on the upstream side with respect to the flow direction of combustion gas.

Furthermore, the cooling gas supply holes 46 may not necessarily be provided in a case where cooling by inner surface cooling or impingement cooling is enough, that is, in a case where the temperatures of the body part 40 and the porous part 42 can be kept at the allowable temperature or below only by cooling the high-temperature component 10 for a gas turbine from inside.

In some embodiments, as depicted in FIG. 7, the porous part 42 is disposed on at least a part of the body part 40. That is, the porous part 42 is formed to have a layer shape so as to cover at least a part of the body part 40, and constitutes a thermal insulation layer. The body part 40 has a plurality of cooling gas supply holes 46 for supplying cooling gas to the porous part 42. The cooling gas supply holes 46 connect the internal space 44 and the porous part 42 fluidically.

Furthermore, as depicted in FIG. 7, the high-temperature component 10 for a gas turbine is configured such that the cross-sectional area (flow-passage area) of each of the plurality of cooling gas supply holes 46, that is, the equivalent diameter, is decided in accordance with one or both of the distributions of the thermal load and the pressure difference applied to the porous part 42.

With the above configuration, the cross-sectional area of each of the cooling gas supply holes 46 is decided in accordance with one or both of the distributions of the thermal load and the pressure difference applied to the porous part 42, and thereby it is possible to prevent local and excessive heating of the porous part 42, as well as an excessive and local increase in the passing flow rate of cooling gas, with a simple configuration.

For instance, the thermal load applied to the porous part 42 is higher toward the upstream side with respect to the flow direction of combustion gas. Thus, the cooling gas supply holes 46 are formed such that the cross-sectional area of the cooling gas supply holes 46 increases toward the upstream with respect to the flow direction of combustion gas.

Further, for instance, the pressure difference applied to the porous part 42 is smaller toward the upstream side with respect to the flow direction of combustion gas. Thus, the cooling gas supply holes 46 are formed such that the cross-sectional area of the cooling gas supply holes 46 increases toward the upstream with respect to the flow direction of combustion gas.

Furthermore, for instance, in a case where the high-temperature component 10 for a gas turbine is a blade such as the stationary vane 11 or the rotor blade 19, the static pressure of the gas path has a distribution at each of the suction side and the pressure side of the airfoil parts 13, 21, as depicted in part (b) of FIG. 15, and the pressure difference has a distribution. Specifically, the pressure difference is the smallest at the middle section with respect to the flow direction at the pressure side, and the largest at the middle section with respect to the flow direction at the suction side. Thus, the cross-sectional area of cooling gas supply holes 46 may be decided in accordance with the above distribution of pressure difference, so that the cross-sectional area of cooling gas supply holes 46 increases as the pressure difference becomes smaller, at each of the suction side and the pressure side of the airfoil parts 13, 21.

Furthermore, for instance, in a case where the high-temperature component 10 for a gas turbine is a blade such as the stationary vane 11 or the rotor blade 19, the thermal load has a distribution at each of the suction side and the pressure side of the airfoil parts 13, 21, as depicted in part (b) of FIG. 16. Specifically, the thermal load at the pressure side is the highest at the leading edge with respect to the flow direction, reaches its minimum at a section immediately downstream the leading edge, gradually increases over a section downstream thereof, and then gradually decreases to the trailing edge over a section further downstream thereof. The thermal load at the suction side is the highest at the leading edge with respect to the flow direction, reaches its minimum at a section immediately downstream the leading edge, and then gradually increases to the trailing edge over a section downstream thereof. Thus, the cross-sectional area of cooling gas supply holes 46 may be decided in accordance with the above distribution of thermal load, so that the cross-sectional area of cooling gas supply holes 46 increases as the thermal load becomes higher, at each of the suction side and the pressure side of the airfoil parts 13, 21.

In some embodiments, as depicted in FIGS. 11 and 13, the body part 40 has a cavity 48 formed between the porous part 42 and at least one of the plurality of cooling gas supply holes 46, the cavity 48 having a greater cross-sectional area than the at cooling gas supply hole 46. The cavity 48 is disposed adjoining to the porous part 42.

With the above configuration, with the cavity 48 having a greater cross-sectional area than the cooling gas supply hole 46 disposed between the porous part 42 and the cooling gas supply hole 46, it is possible to supply cooling gas to a broader region of the porous part 42. As a result, it is possible to prevent local and excessive heating of the porous part 42, and a local and excessive increase in the passing flow rate of cooling gas.

The cavity 48 has, for instance, a column shape or a rectangular shape that is coaxial with the cooling gas supply hole 46. Alternatively, the cavity 48 may have a groove shape or a channel shape extending along the porous part 42.

In some embodiments, the cavity 48 is formed so that the cross-sectional area of the cavity 48 is as large as possible.

In some embodiments, cavities 48 are formed so that the wall separating the cavities 48 is as thin as possible.

In some embodiments, as depicted in FIG. 10, the porous part 42 is arranged in accordance with one or both of the distributions of the thermal load and the pressure difference applied to the body part 40.

With the above configuration, since the porous part 42 is arranged in accordance with one or both of the distributions of the thermal load and the pressure difference applied to the body part 40, it is possible to protect the body part 40 from heat while reducing the proportion of the porous part 42 to the high-temperature component 10 for a gas turbine.

For instance, as depicted in FIG. 10, the porous part 42 is disposed only on the upstream side with respect to the flow direction of combustion gas.

In some embodiments, as depicted in FIGS. 8, 11, 12, 13, 15, and 16, the porosity rate of the porous part 42 has a distribution in accordance with one or both of the distributions of the thermal load and the pressure difference applied to the porous part 42.

With the above configuration, the porosity rate of the porous part 42 has a distribution in accordance with one or both of the distributions of the thermal load and the pressure difference applied to the porous part 42, and thereby it is possible to prevent local and excessive heating of the porous part 42, as well as an excessive and local increase in the passing flow rate of cooling gas.

For instance, the thermal load applied to the porous part 42 is higher toward the upstream side with respect to the flow direction of combustion gas. Thus, the porous part 42 (42a to 42e) is formed such that the porosity rate of the porous part 42 increases toward the upstream side with respect to the flow direction of combustion gas, that is, increases gradually.

Further, for instance, the pressure difference applied to the porous part 42 is smaller toward the upstream side with respect to the flow direction of combustion gas. Thus, the porous part 42 (42a to 42e) is formed such that the porosity rate of the porous part 42 increases toward the upstream side with respect to the flow direction of combustion gas, that is, increases gradually.

Furthermore, for instance, in a case where the high-temperature component 10 for a gas turbine is a blade such as the stationary vane 11 or the rotor blade 19, the static pressure of the gas path has a distribution at each of the suction side and the pressure side of the airfoil parts 13, 21, as depicted in part (b) of FIG. 15, and the pressure difference has a distribution. Specifically, the pressure difference is the smallest at the middle section with respect to the flow direction at the pressure side, and the largest at the middle section with respect to the flow direction at the suction side. Thus, the distribution of the porosity rate of the porous part 42 may be decided in accordance with the above distribution of pressure difference, so that the porosity rate of the porous part 42 increases as the pressure difference becomes smaller, at each of the suction side and the pressure side of the airfoil parts 13, 21, as depicted in part (c) of FIG. 15.

Furthermore, for instance, in a case where the high-temperature component 10 for a gas turbine is a blade such as the stationary vane 11 or the rotor blade 19, the thermal load has a distribution at each of the suction side and the pressure side of the airfoil parts 13, 21, as depicted in part (b) of FIG. 16. Specifically, the thermal load at the pressure side is the highest at the leading edge with respect to the flow direction, reaches its minimum at a section immediately downstream the leading edge, gradually increases over a section downstream thereof, and then gradually decreases to the trailing edge over a section further downstream thereof. The thermal load at the suction side is the highest at the leading edge with respect to the flow direction, reaches its minimum at a section immediately downstream the leading edge, and then gradually increases to the trailing edge over a section downstream thereof. Thus, the distribution of the porosity rate of the porous part 42 may be decided in accordance with the above distribution of thermal load, so that porosity rate of the porous part 42 increases as the thermal load becomes higher, at each of the suction side and the pressure side of the airfoil parts 13, 21, as depicted in part (c) of FIG. 16.

In some embodiments, as depicted in FIGS. 9 and 17, the thickness of the porous part 42 has a distribution in accordance with one or both of the thermal load and the pressure difference applied to the porous part 42.

With the above configuration, the thickness of the porous part 42 has a distribution in accordance with one or both of the distributions of the thermal load and the pressure difference applied to the porous part 42, and thereby it is possible to prevent local and excessive heating of the porous part 42, as well as an excessive and local increase in the passing flow rate of cooling gas.

For instance, the thermal load applied to the porous part 42 is higher toward the upstream side with respect to the flow direction of combustion gas. Thus, the porous part 42 is formed such that the thickness of the porous part 42 decreases toward the upstream side with respect to the flow direction of combustion gas, that is, decreases gradually.

Further, for instance, the pressure difference applied to the porous part 42 is smaller toward the upstream side with respect to the flow direction of combustion gas. Thus, the porous part 42 is formed such that the thickness of the porous part 42 decreases toward the upstream side with respect to the flow direction of combustion gas, that is, decreases gradually.

Furthermore, for instance, in a case where the high-temperature component 10 for a gas turbine is a blade such as the stationary vane 11 or the rotor blade 19, the static pressure of the gas path has a distribution at each of the suction side and the pressure side of the airfoil parts 13, 21, as depicted in part (b) of FIG. 15, and the pressure difference has a distribution. Specifically, the pressure difference is the smallest at the middle section with respect to the flow direction at the pressure side, and the largest at the middle section with respect to the flow direction at the suction side. Thus, the distribution of the thickness of the porous part 42 may be decided in accordance with the above distribution of pressure difference, so that thickness of the porous part 42 decreases as the pressure difference becomes smaller, at each of the suction side and the pressure side of the airfoil parts 13, 21.

Furthermore, for instance, in a case where the high-temperature component 10 for a gas turbine is a blade such as the stationary vane 11 or the rotor blade 19, the thermal load has a distribution at each of the suction side and the pressure side of the airfoil parts 13, 21, as depicted in part (b) of FIG. 16. Specifically, the thermal load at the pressure side is the highest at the leading edge with respect to the flow direction, reaches its minimum at a section immediately downstream the leading edge, gradually increases over a section downstream thereof, and then gradually decreases to the trailing edge over a section further downstream thereof. The thermal load at the suction side is the highest at the leading edge with respect to the flow direction, reaches its minimum at a section immediately downstream the leading edge, and then gradually increases to the trailing edge over a section downstream thereof. Thus, the distribution of the thickness of the porous part 42 may be decided in accordance with the above distribution of thermal load, so that the thickness of the porous part 42 decreases as the thermal load becomes higher, at each of the suction side and the pressure side of the airfoil parts 13, 21.

In some embodiments, as depicted in FIG. 12, the porous part 42 may constitute the entire body part 40 of the high-temperature component 10 for a gas turbine.

In some embodiments, as depicted in FIG. 13, a thermal barrier coating (TBC) 50 may be disposed on the porous part 42. The thermal barrier coating 50 is formed of a ceramic such as yttrium-stabilized zirconium, for instance, and has a smaller porosity rate than the porous part 42. The thermal barrier coating 50 may have cooling gas discharge holes 52 formed thereon, for discharging cooling gas.

In some embodiments, as depicted in FIG. 14, a bond layer (middle layer) 54 may be disposed between the body part 40 and the porous part 42. The bond layer 54 bonds the body part 40 and the porous part 42, and includes, for instance, fired aluminum phosphate or a MCrAlY alloy. Herein, M of the MCrAlY alloy is one or two selected from a group consisting of Ni, Co, and Fe. MCrAlY alloy has a composition represented by Co-32Ni-21Cr-8Al-0.5Y, for example.

In some embodiments, as depicted in FIGS. 5 to 14, the porous part 42 is disposed at least on the outer surface side (gas-path side) of the wall portion 29 of the ring segment 27.

In some embodiments, as depicted in FIGS. 15 to 17, the porous part 42 is disposed at least on the outer surface side (gas-path side) of the airfoil part 21 of the rotor blade 19.

In some embodiments, as depicted in FIG. 18, the porous part 42 is disposed at least on the outer surface side (gas-path side) of the airfoil part 13 of the stationary vane 11.

In the above described embodiments, the body part 40 or the porous part 42 constitutes at least a part of the rotor blade 19, the stationary vane 11, or the ring segment 27 being the high-temperature component 10 for a gas turbine. In some embodiments, the high-temperature component 10 for a gas turbine is the combustor 5, as depicted in FIG. 1. In this case, the body part 40 or the porous part 42 constitutes at least a part of the combustor 5, for instance, a combustion cylinder or a transition piece.

With the above configuration, in the combustor 5 being the high-temperature component 10 for a gas turbine, similarly to the rotor blade 19, the stationary vane 11, and the ring segment 27, it is possible to prevent local and excessive heating of the body part 40 and the porous part 42, and a local and excessive increase in the passing flow rate of the cooling gas.

The gas turbine blade, that is, the stationary vane 11 or the rotor blade 19 according to an embodiment of the present invention includes porous parts 42, 48 that constitute at least the trailing-edge portion 56 of the airfoil part 21 like the rotor blade 19 depicted in FIG. 17, and through which cooling gas can pass through.

Further, the porous parts 42, 58 have a porosity rate distribution such that cooling gas inside the airfoil part 21 flows out from the trailing edge of the airfoil part 21 through the porous part 58.

More specifically, the porous part (inner porous part) 58 is covered with the porous part (outer porous part) 42, and the porosity rate of the porous part 58 is higher than the porosity rate of the porous part 42. Thus, cooling gas passes through the porous part 58 more easily than the porous part 42, and the cooling gas is guided to the trailing edge of the airfoil part 21 by the porous part 58. Meanwhile, the thickness of the porous part 42 is greater at the upstream side of the trailing-edge portion 56 so that cooling gas does not flow out before the trailing edge.

With the above configuration, the trailing-edge portion 56 of the airfoil part 21 is formed by the porous parts 42, 58, and the cooling gas is allowed to flow through the porous part 58, whereby it is possible to discharge cooling gas from the trailing edge of the airfoil part 21 even if the thickness of the trailing-edge portion 56 of the airfoil part 21 is small. At this time, with the porous parts 42, 58 having a distribution such that cooling gas flows out from the trailing edge of the airfoil part 21, it is possible to prevent cooling gas from flowing out entirely from the suction side or the pressure side of the trailing-edge portion 56 before arriving at the trailing edge of the airfoil part 21, which makes it possible to discharge cooling gas from the trailing edge.

In some embodiments, like the stationary vane 11 depicted in FIG. 18, the internal space 44 is divided into a plurality of chambers 60, and each chamber 60 is supplied with cooling gas in parallel. Further, in a case where the flow-out rates of cooling gas from the chambers 60 due to pressure difference cannot be controlled sufficiently by the number or the cross-sectional area of cooling gas supply holes 46, or the porosity rate or the thickness of the porous part 42, an adjustment portion 62 is disposed in the flow passages of cooling gas to the chambers 60.

With the above configuration, by providing the adjustment portion 62, it is possible to control the static pressure of cooling gas in the chambers 60, and prevent a great amount of cooling gas from flowing out from a particular chamber 60.

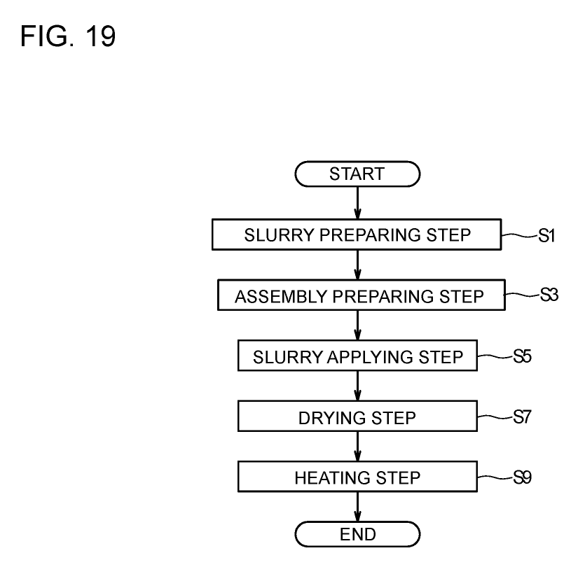

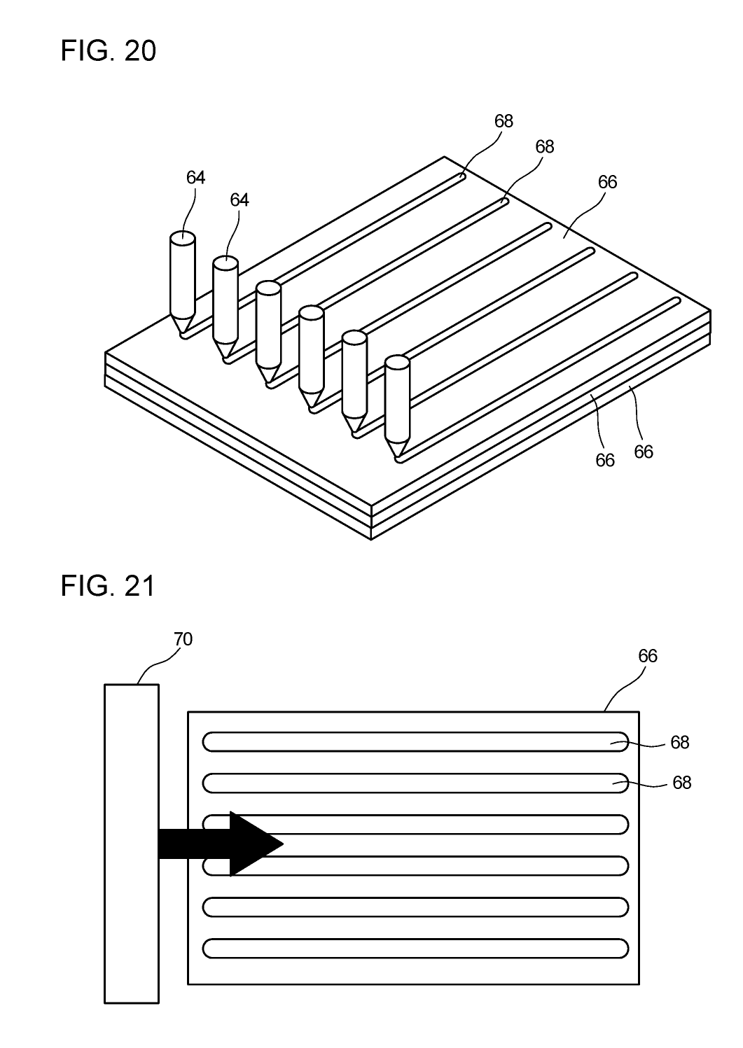

FIG. 19 is a flowchart schematically showing an example of the procedure of the method to produce a porous part to be applied to a high-temperature component 10 for a gas turbine according to an embodiment of the present invention.

The method of producing a porous part includes, as depicted in FIG. 19, a slurry preparing step S1, an assembly preparing step S3, a slurry applying step S5, a drying step S7, and a heating step S9.

The slurry preparing step S1 includes preparing, as ingredients of slurry, water as a solvent, e.g. distilled water or deionized water, ceramic powder, pore generation powder, a dispersing agent if necessary, and a bonding agent if necessary. Then, the ingredients are stirred and mixed, and thereby slurry is prepared.

The ceramic powder is a powder containing one or more, or ingredients thereof, selected from a group consisting of SiC, Si₃N₄, βSiAlON, AlN, TiB₂, BN, WC, and the like.

The pore generation powder is a powder including one or more selected from a group consisting of an organic material, carbon, graphite, and the like. The organic material powder is, for instance, an acrylic, styrene, or polyethylene polymer powder.

The dispersing agent contains one or more selected from a group consisting of polycarboxylic ammonium salt, polycarboxylic sodium salt, neutralized polyphosphate amino alcohol, naphthalenesulfonate ammonium salt, polycarboxylic alkylamine salt, non-ionic surfactant, cationic surfactant, and the like.

The bonding agent contains one or more selected from a group consisting of polyvinyl alcohol resin, acrylic resin, and paraffin.

The assembly preparing step S3 includes preparing an assembly of ceramic fibers. The assembly of ceramic fibers is, for instance, a bundle or a woven sheet of ceramic fibers. The ceramic fiber includes one or more, or ingredients thereof selected from a group consisting of SiC, SiTiCO, SiZrCO, SiAlCO, Si₃N₄, and the like.

The slurry applying step S5 includes applying slurry to the assembly of ceramic fibers. At this time, the slurry is applied to the assembly of ceramic fibers so that the slurry enters the gaps between the ceramic fibers.

For instance, the slurry applying step S5 includes immersing the assembly of ceramic fibers into the slurry under a pressure lower than the atmospheric pressure. Alternatively, the slurry is applied by rolling the assembly of ceramic fibers after coating the assembly with slurry.

The drying step S7 includes drying the slurry applied to the assembly of ceramic fibers in an atmosphere of 120 C°, for instance, to form a green body (intermediate body).

The heating step S9 includes heating the green body under a reduction atmosphere of 1200 C°, for instance, where the ceramic powder becomes sintered and the pore generation powder disappears.

According to the above method of producing a porous part, the pore generation powder is mixed into the slurry in the slurry preparing step S1 and the pore generation powder is removed in the heating step S9, whereby it is possible to form pores that correspond to the pore generation powder, inside the porous part.

Furthermore, according to the above method of producing a porous part, it is possible to control the porosity rate by adjusting the amount of pore generation powder to be added to the slurry.

FIG. 20 is a schematic perspective view for describing an example of the slurry applying step S5. FIG. 21 is a schematic plan view for describing an example of the slurry applying step S5.

In some embodiments, as depicted in FIG. 20, the slurry 68 is applied in parallel to a woven sheet 66 of ceramic fibers by using a plurality of dispensers 64. At this time, the plurality of dispensers 64 apply slurry 68 containing different amounts of pore generation powder in parallel.

Then, as depicted in FIG. 21, the roller 70 is moved in the extending direction of the slurry 68 to cause the slurry to permeate into the woven sheet 66.

With the above configuration, by applying the slurry 68 containing different amounts of the pore generation powder in parallel and moving the roller 70 along the extending direction of the slurry 68, it is possible to produce a porous part whose porosity rate changes in stages in a direction orthogonal to the extending direction of the slurry 68.

Meanwhile, by moving the roller 70 in a direction orthogonal to the extending direction of the slurry 68, it is possible to produce a porous part whose porosity rate changes smoothly.

Further, as depicted in FIG. 21, a plurality of woven sheets 66 may be stacked in accordance with the thickness of the porous part 42. In this case, a work of applying the slurry 68 to a woven sheet 66 by using the dispenser 64 and rolling the woven sheet 66 with the roller 70 may be repeated each time another woven sheet 66 is staked. Alternatively, the roller 70 may be used in the end collectively for a plurality of woven sheets 66 after repeatedly applying the slurry 68 to each woven sheet 66 with the dispenser 64.

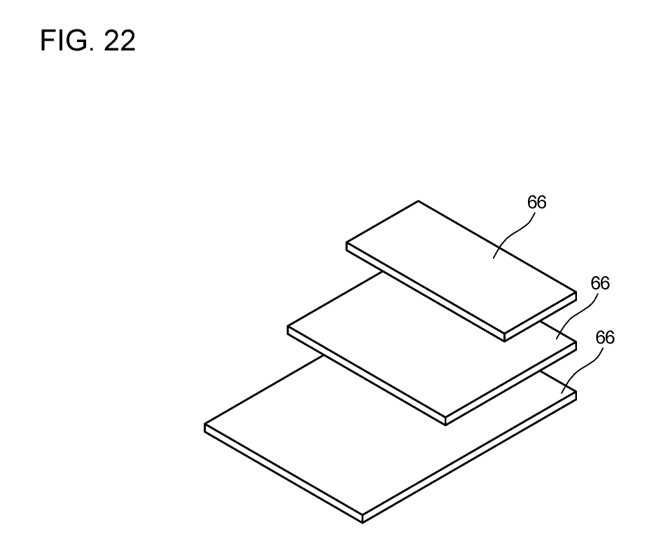

FIG. 22 is a schematic perspective view showing a plurality of woven sheets 66 prepared in the assembly preparing step S3. In some embodiments, a plurality of woven sheets 66 having different sizes are prepared, and stacked.

With the above configuration, it is possible to change the thickness of the porous part 42 in accordance with the thermal load and the pressure difference with a simple configuration.

Embodiments of the present invention were described in detail above, but the present invention is not limited thereto, and various amendments and modifications may be implemented.

In particular, while the above description is largely based on an embodiment where the ring segment 27 is the high-temperature component 10 for a gas turbine, the configuration described in relation to the ring segment 27 can be also applied to the combustor 5, the stationary vane 11, and the rotor blade 19, and the configuration described in relation to the stationary vane 11 can be also applied to the combustor 5, the rotor blade 19, and the ring segment 27, and the configuration described in relation to the rotor blade 19 can be also applied to the combustor 5, the stationary vane 11, and the ring segment 27.

Further, the high-temperature component 10 for a gas turbine is a component at least a part of which is to be heated to a temperature of 800° C. or higher, for instance, and is not limited to the combustor 5, the stationary vane 11, the rotor blade 19, or the ring segment 27 described above.

Furthermore, the pattern of the slurry 68 applied to the woven sheet 66 in the slurry applying step S5 is not limited to parallel as depicted in FIGS. 20 and 21, and can be suitably selected in accordance with the distribution of the thermal load or the pressure difference.

### DESCRIPTION OF REFERENCE NUMERALS

1 Gas turbine
3 Compressor
5 Combustor
7 Turbine
9 Rotor shaft
10 High-temperature component for gas turbine
11 Stationary vane
12 Housing
13 Airfoil part
15, 17 Platform
19 Rotor blade
21 Airfoil part
23 Platform
25 Blade root portion
27 Ring segment
29 Wall portion
31, 33 Engaging portion
40 Body part
42, 42a to 43e Porous part
44 Internal space
46 Cooling gas supply hole
48 Cavity
50 Thermal barrier coating
52 Cooling gas discharge hole
54 Bond layer
56 Trailing-edge portion
58 Porous part
60 Chamber
62 Narrowing portion
64 Dispenser
66 Woven sheet of ceramic fibers
68 Slurry

1-10. (canceled)

11. A gas turbine blade, comprising:
a porous part which constitutes at least a trailing edge portion of an airfoil part and through which a cooling gas is passable,
wherein the porous part is configured such that the cooling gas inside the airfoil part flows out through the porous part from a trailing edge of the airfoil part, and
wherein the porous part includes:
an outer porous part; and
an inner porous part covered with the outer porous part, the inner porous part having a higher porosity rate than the outer porous part.

12. The gas turbine blade according to claim 11, wherein the outer porous part at an upstream side of the trailing edge portion is thicker than the outer porous part at a downstream side of the trailing edge portion

13. The gas turbine blade according to claim 11, further comprising a body part covered with the outer porous part.

14. The gas turbine blade according to claim 13, wherein the body part includes an internal space supplied with a cooling gas.

15. The gas turbine blade according to claim 14, wherein the body part includes a cooling gas supply hole provided at a downstream end of the body part for fluidically connecting the internal space and the inner porous part.

16. A gas turbine, comprising:
the gas turbine blade according to claim 11.
